(19) United States
(12) Patent Application Publication
(10) Pub. No.: US 2010/0017261 A1
(43) Pub. Date: Jan. 21, 2010

(54) EXPERT SYSTEM AND SERVICE FOR LOCATION-BASED CONTENT INFLUENCE FOR NARROWCAST

(75) Inventors: Gregory M. Evans, Raleigh, NC (US); Christopher M. Amidon, Apex, NC (US)

Correspondence Address: WITHROW & TERRANOVA CT, 100 REGENCY FOREST DRIVE , SUITE 160, CARY, NC, 27518, US

(73) Assignee: KOTA ENTERPRISES, LLC, WILMINGTON, DE (US)

(21) Appl. No.: 12/174,854

(22) Filed: Jul. 17, 2008

(51) Int. Cl. G06Q 10/00; G06Q 30/00

(52) U.S. Cl. 705/10; 705/14.58

(57) ABSTRACT

A method and system are provided for influencing media playback by target users in a defined geographic area in order to create social groups for targeted advertising. In one embodiment, an expert system receives input from an advertisement agency defining a geographic area of interest and an advertisement strategy for the geographic area of interest. The expert system then influences media playback by target users located within the geographic area of interest in a manner that influences creation of one or more social groups centered around media playback and satisfying the advertisement strategy for the geographic area of interest. When there is convergence between a social group created via the influence of the expert system and the advertisement strategy, the expert system notifies one or more advertisement systems, which, in response, present targeted advertisements to the target users forming the social group.

### FIELD OF THE INVENTION

The present invention relates to targeted advertisements and more specifically relates to influencing creation of a location-centric social group for a targeted advertisement.

### BACKGROUND OF THE INVENTION

During the second quarter of 2007, location-based services accounted for approximately half of the $118 million spent on mobile advertisement. Further, the total mobile advertisement market for North America is projected to grow to $2.3 billion in annual revenue by 2012. Additionally, mobile telephone tracking via Global Positioning System (GPS) receivers and tower triangulation has been governmentally mandated. Thus, there is a desire for a system and method that leverages such mobile device tracking to provide improved targeted advertisements.

### SUMMARY OF THE INVENTION

The present invention relates to influencing target users in a defined geographic area in order to create social groups for a desired service or function such as, but not limited to, targeted advertising. In one embodiment, an expert system receives input from an advertisement agency defining a geographic area of interest and an advertisement strategy for the geographic area of interest. The expert system then influences media playback by target users located within the geographic area of interest in a manner that influences creation of one or more social groups centered around media playback and satisfying the advertisement strategy for the geographic area of interest. When there is convergence between a social group created via the influence of the expert system and the advertisement strategy, the expert system notifies one or more advertisement systems, which, in response, present targeted advertisements to the target users forming the social group.

In one embodiment, the advertisement strategy includes information defining a desired social group to be created by influencing playback of media content by users in the geographic area of interest. More specifically, the desired social group may be defined as, for example, users playing or otherwise experiencing the same or similar media content. In addition, the advertisement strategy may define a minimum number of users for the social group, one or more criteria for identifying target users for the social group, or both. The expert system identifies target users that are located within the geographic area of interest and, optionally, have user profiles satisfying the one or more criteria defined for the advertisement strategy. Once the target users are identified, the expert system influences playback of media content by the target users in order to influence creation of one or more social groups satisfying the advertisement strategy. In one embodiment, playback of media content is influenced via one or more media recommendation engines. The expert system monitors user interactions of the target users in response to the influences of the expert system and continues to influence media playback until one or more social groups satisfying the advertisement strategy are created. The expert system then notifies one or more advertisement systems of the social groups. In response, for each social group, the one or more advertisement systems present a targeted advertisement to the target users forming the social group.

In one embodiment, the one or more advertisement systems present targeted advertisements via one or more environmental advertisement presentation devices such as, for example, one or more electronic billboards. As such, upon being notified by the expert system of a social group satisfying the advertisement strategy for the geographic area of interest, the one or more advertisement systems select a targeted advertisement for the social group and present the targeted advertisement, or cause a targeted advertisement to be presented, via one or more environmental advertisement presentation devices in or near a corresponding sub-area of the geographic area of interest in which the social group is located. In another embodiment, the one or more advertisement systems present targeted advertisements via narrowcasting targeted advertisements to mobile devices of users. As such, upon being notified by the expert system of a social group satisfying the advertisement strategy for the geographic area of interest, the one or more advertisement systems select a targeted advertisement for the social group and narrowcast the targeted advertisement to mobile devices of the target users forming the social group, mobile devices of all target users in a corresponding sub-area of the geographic area of interest in which the social group is located, or mobile devices of all users in the sub-area of the geographic area of interest in which the social group is located.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a flow chart illustrating a process for influencing media playback of target users in a geographic area of interest in order to create one or more social groups satisfying an advertisement strategy for the delivery of targeted advertisements according to one embodiment of the present invention;

FIG. 2 graphically illustrates the process of FIG. 1 according to an exemplary embodiment of the present invention;

FIG. 3 illustrates a system for influencing media playback of target users in a geographic area of interest in order to create one or more social groups satisfying an advertisement strategy for the delivery of targeted advertisements according to one embodiment of the present invention; and

FIG. 4 is a block diagram of a server hosting the expert system of FIG. 3 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to influencing target users in a geographic area of interest in order to create one or more social groups satisfying a grouping strategy. Once the one or more social groups satisfying the grouping strategy are created, a desired service or function is provided with respect to those social groups. Note that the discussion herein focuses primarily on an embodiment of the present invention wherein the grouping strategy is an advertisement strategy for a geographic area of interest. Target users located within the geographic area of interest are then identified and influenced in order to create one or more social groups satisfying the advertisement strategy. An advertisement system is then notified of the creation or existence of the one or more social groups. In response, the advertisement system provides targeted advertisements to users forming the one or more social groups. However, the present invention is not limited thereto. Other types of grouping strategies as well as corresponding services or functions will be apparent to one of ordinary skill in the art upon reading this disclosure and are to be considered within the scope of the present invention.

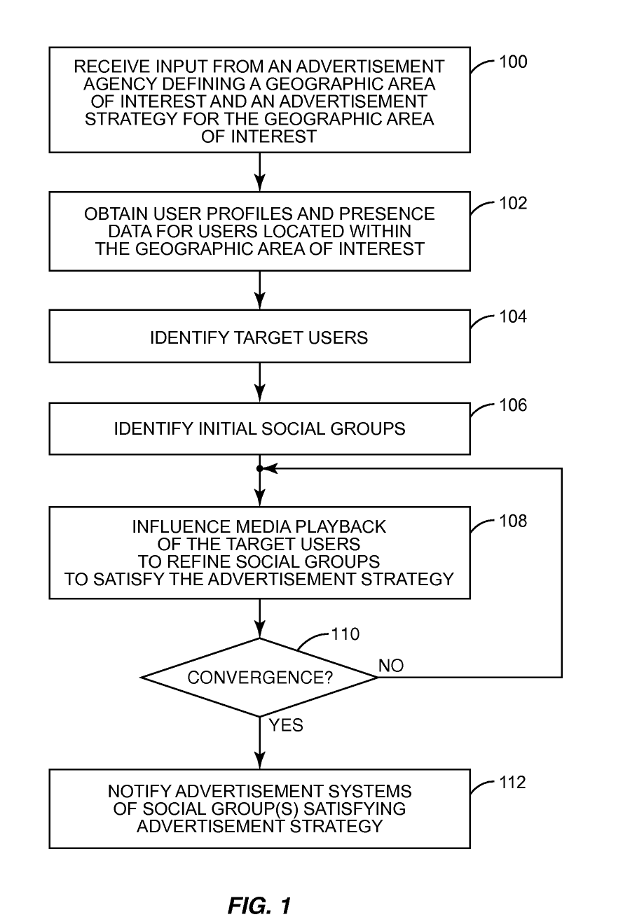

FIG. 1 is a flow chart illustrating a process for influencing media playback of target users in a geographic area of interest in order to create one or more social groups satisfying an advertisement strategy for the delivery of targeted advertisements according to one embodiment of the present invention. First, an expert system receives input from an advertisement agency defining a geographic area of interest and an advertisement strategy for the geographic area of interest (step 100). The input may be input from a human working at an advertisement agency or automated input from a computing device associated with the advertisement agency. Note that the input may alternatively be received from a particular advertiser. The geographic area of interest may be any geographic area such as, for example, a mall, a particular store within a mall, a city, a city block, or the like. Further, the geographic area of interest may be defined using geographic coordinates. However, the geographic area of interest may alternatively be defined using other information such as, for example, a street address.

The advertisement strategy includes information defining a desired social group, where the social group is centered around playback of media content such as, for example, music, videos, advertisements, or the like. As discussed below, the expert system operates to create one or more of the desired social groups by influencing playback of media content by users in the geographic area of interest. The desired social group is generally defined in terms of the relationship of media content to be played by users in the social group. As a first example, the desired social group may be defined as users located within the geographic area of interest that are playing the same media content. As a second example, the desired social group may be defined as users located within the geographic area of interest that are playing media content from the same genre such as the same music genre or same video genre. As a third example, the desired social group may be defined as users located within the geographic area of interest that are playing music by the same artist. As a final example, the desired social group may be defined as users located within the geographic area of interest that are playing or listening to the same broadcast radio station such as, for example, the same Internet Protocol (IP) based radio station. Note that in the preferred embodiment, the advertisement strategy does not specify the particular media content desired to be played by the users in the desired social group. However, in an alternative embodiment, the advertisement strategy may specify a particular media item to be played by the users in the desired social group, a particular genre of media items to be played by the users in the desired social group, a particular music artist for which songs are to be played by the users in the desired social group, or the like.

In addition, the advertisement strategy may define a minimum number of users for the social group, one or more criteria for identifying target users for the social group, or both. The one or more criteria for identifying target users may be compared to user profiles and/or presence data for users located within the geographic area of interest in order to identify target users for the advertisement strategy. In general, the one or more criteria may be any type of criteria suitable for use in targeted advertising. For example, the one or more criteria for identifying target users may include demographic criteria such as an age range, gender, income level, profession, marital status, home address, or the like. In additional or alternatively, the one or more criteria for identifying target users may include, for example, one or more items required to have been purchased by the users, one or more media items required to have been played by the users, or the like.

The expert system then obtains user profiles and presence data for users located within the geographic area of interest (step 102). More specifically, in one embodiment, the expert system first identifies users located within the geographic area of interest. In the preferred embodiment, users are equipped with mobile devices such as mobile telephones. Locations of the mobile devices, and thus the users, may be determined using any suitable technique. For example, the mobile devices may include or be associated with Global Positioning System (GPS) receivers. As an exemplary alternative, the locations of the mobile devices may be determined using triangulation. In one embodiment, the locations of the mobile devices, and thus the users, may be maintained by a remote service. For example, if the mobile devices are mobile telephones, the locations of the mobile devices may be stored by a location tracking service of one or more associated mobile telecommunications networks. The expert system may then query the location tracking service to identify users within the geographic area of interest. Alternatively, the expert system may maintain locations of the mobile devices of the users in a local or associated database and query that database to identify users located in the geographic area of interest. Note that other schemes for identifying users located in the geographic area of interest will be apparent to one of ordinary skill in the art and are to be considered within the scope of the present invention.

Once the users located in the geographic area of interest are identified, the expert system obtains user profiles and presence data for the identified users. Again, in the preferred embodiment, the users are equipped with mobile devices. As such, the expert system may obtain the user profiles and presence data from the mobile devices of the identified users. Alternatively, the user profiles and/or the presence data may be requested and obtained from one or more remote services. For example, the user profiles and/or presence data may be maintained by and requested from one or more remote services such as remote services associated with one or more mobile telecommunications networks providing service to the mobile devices of the users, one or more social networking services such as one or more social networking websites, or the like.

A user profile of a user may include, for example, demographic information such as the age of the user, the gender of the user, an annual income of the user, a profession of the user, marital status of the user, home address of the user, or the like. The user profile of the user may additionally or alternatively include, for example, a purchase history identifying one or more items recently purchased by the user. Still further the user profile may include media preferences of the user such as, for example, preferred media type (e.g., audio, video, advertisements, or the like), preferred music genre(s), preferred video genre(s), preferred music artists, or the like. The presence data may include a location of the user, a location history of the user, information identifying friends of the user that are located near the user, connection status of the mobile device of the user, device attributes of the mobile device of the user, a current playlist being played by the mobile device of the user, a play history of the user, a log of user interactions during playback of media content such as pausing, fast-forwarding, skipping, or the like.

The expert system then identifies target users located within the geographic area of interest (step 104). In this embodiment, the target users are users located within the geographic area of interest having user profiles and/or presence data satisfying the one or more criteria specified by the advertisement strategy. However, in an alternative embodiment, the advertisement strategy may not specify one or more criteria for target users in which case the target users would be all users located within the geographic area of interest.

At this point, the expert system identifies initial social groups within the geographic area of interest (step 106). More specifically, in this embodiment, the expert system sub-divides the geographic area of interest into a number of sub-areas, where, for each sub-area, a substantial number of the target users located in the sub-area are playing the same or similar media content or prefer the same or similar content and form an initial social group. The initial social groups within the geographic area of interest may be identified by the expert system based on the locations of the target users, the presence data of the target users, and/or the user profiles of the target users.

The expert system then influences media playback of the target users to refine the initial social groups in order to influence creation of one or more social groups satisfying the advertisement strategy (step 108). More specifically, in one embodiment, the expert system influences media playback of the target users in adjacent sub-areas in a manner that influences those target users to form a refined social group that satisfies the requirements of the advertisement strategy or is closer to satisfying the advertisement strategy. In other words, the expert system influences media playback of the target users in adjacent sub-areas in a manner that influences those target users to merge into a social group that satisfies the requirements of the advertisement strategy or is closer to satisfying the advertisement strategy. Thus, for example, if the desired social group defined by the advertisement strategy is at least a defined number of target users listening to the same media content, the expert system may influence media playback of the target users to refine the social groups in order to create one or more social groups having at least the defined number of users playing the same media content.

In one embodiment, playback of media content is influenced via one or more media recommendation engines under the instruction of the expert system. For example, a recommendation engine may be hosted by a central server and operate to send media recommendations to the mobile devices of the target users under the control of the expert system. Note that the expert system may select the media content to be recommended to the target users. Alternatively, the expert system may instruct the recommendation engine to select the recommendations based on the media content currently being played by or preferred by the target users in the social groups desired to be refined or merged. For example, based on the media content currently being played by or preferred by target users in two or more adjacent social groups, the expert system may select one or more predefined rules or generate one or more rules enabling the recommendation engine to select one or more appropriate media recommendations for influencing the target users in those social groups to merge into a social group that satisfies or more closely satisfies the requirements of the advertisement strategy. The media recommendations may be generated for each target user on a per-user basis. Alternatively, the media recommendations may be generated on a per-group basis for each social group of target users or for each of a number of social groups desired to be merged to provide or more closely provide one or more desired social groups for the advertisement strategy. In one embodiment, the media recommendations may identify recommended media items and include references, such as Uniform Resource Locators (URLs), to the recommended media items. The recommended media items may be, for example, recommended songs, recommended videos, recommended IP based radio stations, recommended advertisements, or the like.

For example, if one social group of target users is determined to prefer or be currently listening to music from the Rock genre and another social group of target users in an adjacent sub-area is determined to prefer or be currently listening to music from the Alternative genre, then the expert system may instruct the one or more recommendation engines to recommend music that overlaps the Rock and Alternative music genres or that is near the boundary of the Rock and Alternative music genres to the target users in both of those social groups in an attempt to merge those two groups of target users into a single group listening to the same music. Note that, as discussed below, additional iterations of the influence process may subsequently be performed until one or more of the desired social groups including the minimum number of target users are created.

After influencing media playback by the target users, the expert system monitors user interactions of the target users in response to the influences of the expert system and determines whether there is convergence between any of the refined social groups and the requirements of the advertisement strategy (step 110). More specifically, after influencing media playback by the target users, the expert system obtains user interactions made by the target users in response to the influences such as, for example, playing a recommended media item, skipping a recommended media item, rejecting a media recommendation, or the like. Based on the user interactions, the expert system identifies the refined social groups and updates the sub-areas of the geographic area of interest according to the refined social groups. The expert system then determines whether any of the refined social groups satisfies the requirements of the advertisement strategy. If not, there is no convergence, and the process returns to step 108 in order to further influence media playback by the target users. If so, there is convergence, and the expert system notifies one or more advertisement systems, or alternatively the advertisement agency, of the one or more social groups satisfying the advertisement strategy (step 112). In general, the notification includes information related to the creation of each of the one or more social groups satisfying the advertisement strategy. More specifically, for each social group satisfying the advertisement strategy, the notification includes information describing the social group. The information describing the social group may include information identifying the advertisement strategy, information identifying the geographic area of interest, and information identifying media content being played by the target users forming the social group. In addition, for each social group, the notification may include information identifying the corresponding sub-area of the geographic area of interest in which the target users forming the desired social group are located and information identifying a number of target users in the desired social group.

In response to the notification, for each desired social group, the one or more advertisement systems select one or more targeted advertisements for the desired social group based on the media content being played by the target users in the desired social group. Then, in one embodiment, the one or more advertisement systems then present the one or more targeted advertisements, or causes the one or more targeted advertisements to be presented, to the target users in the desired social group as well as any other users in the vicinity of the target users via one or more environmental advertisement presentation devices within or near the sub-area of the geographic area of interest in which the desired social group is located. The environmental advertisement presentation devices may be, for example, one or more electronic billboards, one or more speakers or sound systems, or the like. In another embodiment, the one or more advertisement systems narrowcast the one or more targeted advertisements, or cause the one or more targeted advertisements to be narrowcast, to the mobile devices of the target users in the desired social group, the mobile devices of all target users in the corresponding sub-area of the geographic area of interest, or the mobile devices of all users in the corresponding sub-area of the geographic area of interest. In yet another embodiment, the one or more advertisement systems may utilize both environmental advertisement presentation devices and narrowcasting to present the one or more targeted advertisements to the target users in the desired social group, all target users in the corresponding sub-area of the geographic area of interest, or all users in the corresponding sub-area of the geographic area of interest.

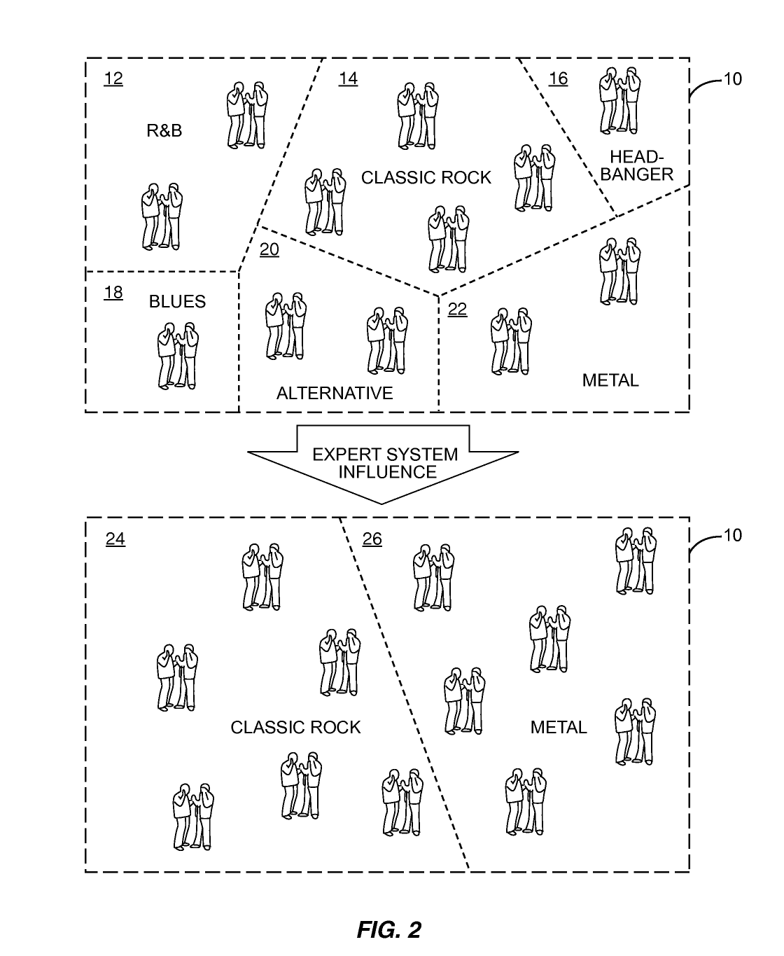

FIG. 2 graphically illustrates the process of FIG. 1 according to one embodiment of the present invention. First, initial social groups of target users within a geographic area of interest 10 are identified, and the geographic area of interest 10 is divided into corresponding sub-areas 12 through 22. In this example, there is an initial R&B social group formed in the sub-area 12 that includes target users that are currently playing or prefer music from the R&B genre, an initial Classic Rock social group formed in the sub-area 14 that includes target users that are currently playing or prefer music from the Classic Rock genre, an initial Head-Banger social group formed in the sub-area 16 that includes target users that are currently playing or prefer music from the Head-Banger genre, an initial Blues social group formed in the sub-area 18 that includes target users that are currently playing or prefer music from the Blues genre, an initial Alternative social group formed in the sub-area 20 that includes target users that are currently playing or prefer music from the Alternative genre, and an initial Metal social group formed in the sub-area 22 that includes target users that are currently playing or prefer music from the Metal genre.

As discussed above, the expert system performs one or more iterations of the influence process to influence media playback by the target users in the geographic area of interest 10 in order to refine the initial social groups to create one or more desired social groups satisfying the advertisement strategy. In this example, the advertisement strategy provides that the desired social group includes at least twelve (12) target users that are playing media content from the same music genre. As such, as a result of the influence of the expert system, the initial social groups are refined to provide two desired social groups satisfying the advertisement strategy. More specifically, in this example, through the influence of the expert system, media playback by the target users in the initial R&B social group, the target users in the initial Blues social group, the target users in the initial Alternative social group, and two of the target users from the initial Classic Rock social group has been successfully influenced such that these target users form a Classic Rock social group in a corresponding sub-area 24 of the geographic area of interest. Likewise, media playback by the remaining target users in the initial Classic Rock social group, the target users in the initial Head-Bangers social group, and the target users in the initial Metal social group has been successfully influenced such that these target users form a Metal social group in a corresponding sub-area 26 of the geographic area of interest 10. Both the Classic Rock social group and the Metal social group satisfy the requirements of the advertisement strategy. As a result, notification is sent to one or more advertisement systems, which, in response, provide targeted advertisements to the target users in each of the sub-areas 24 and 26 and, optionally, other target users or other users in each of the sub-areas 24 and 26.

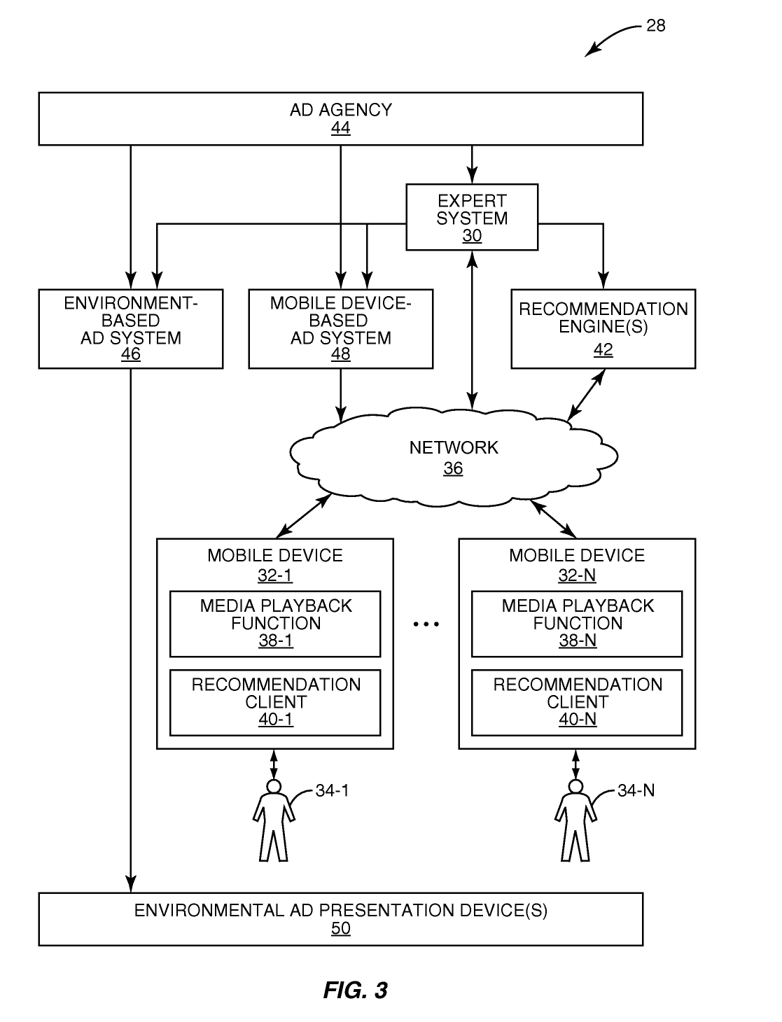

FIG. 3 is a block diagram of a system 28 for influencing media playback by target users in a geographic area of interest in order to create a social group for a targeted advertisement according to one embodiment of the present invention. In general, the system 28 includes an expert system 30 for influencing media playback at a number of mobile devices 32-1 through 32-N of corresponding users 34-1 through 34-N. The expert system 30 is connected to the mobile devices 32-1 through 32-N via a network 36. The network 36 may be any type of network. However, in the preferred embodiment, the network 36 is a Wide Area Network (WAN). As an example, in one embodiment, the mobile devices 32-1 through 32-N are mobile telephones supported by multiple mobile telecommunications carriers, and the network 36 is or includes a Fixed Mobile Convergence (FMC) network. However, the present invention is not limited thereto.

In this embodiment, the mobile device 32-1 includes a media playback function 38-1 and a recommendation client 40-1, each of which may be implemented in software, hardware, or a combination thereof. The media playback function 38-1 generally operates to provide playback of media items such as songs, videos, advertisements, or the like. The recommendation client 40-1 operates to receive and process media recommendations received from one or more recommendation engines 42 under the instruction of the expert system 30. For example, recommendations may be received and processed in a manner similar to that disclosed in U.S. Patent Publication No. 2008/0016205, entitled P2P NETWORK FOR PROVIDING REAL TIME MEDIA RECOMMENDATIONS, which was filed on Jul. 11, 2006 and is hereby incorporated herein by reference in its entirety. Likewise, the mobile devices 32-2 through 32-N include media playback functions 38-2 through 38-N and recommendation clients 40-2 through 40-N, respectively.

In operation, as discussed above, the expert system 30 receives input from an advertisement (“ad”) agency 44. This input may be user input from a user at the advertisement agency 44. However, the present invention is not limited thereto. The input includes information defining a geographic area of interest and an advertisement strategy for the geographic area of interest. The expert system 30 then identifies target users from the users 34-1 through 34-N. The target users are users from the users 34-1 through 34-N that are located within the geographic area of interest and, optionally, have user profiles and/or presence data satisfying one or more criteria defined by the advertisement strategy. As discussed above, the locations of the users 34-1 through 34-N are identified by determining the locations of the mobile devices 32-1 through 32-N using associated GPS receivers, triangulation, or the like. The user profiles and presence data may be obtained from the mobile devices 32-1 through 32-N, one or more remote services, or the like.

Once the target users from the users 34-1 through 34-N are identified, the expert system 30 influences media playback at the corresponding mobile devices of the mobile devices 32-1 through 32-N via the one or more recommendation engines 42 in order to create one or more social groups that satisfy the advertisement strategy. At that point, the expert system 30 notifies an environment-based advertisement (“ad”) system 46, a mobile device-based advertisement (“ad”) system 48, or both.

In response to being notified of a social group satisfying the advertisement strategy, the environment-based advertisement system 46 selects one or more targeted advertisements for the target users in the social group based on the media content being played by the target users forming the social group. The environment-based advertisement system 46 then presents the targeted advertisements via one or more environmental advertisement (“ad”) presentation devices 50 in the vicinity of target users forming the social group. The one or environmental advertisement presentation devices 50 may be, for example, one or more electronic billboards, one or more speakers or sound systems, or the like. Note that the one or more electronic billboards may be any type of electronic display device presenting environmental advertisements. For example, the one or more electronic billboards may be large screen television devices such as large screen plasma or LCD televisions, projectors for displaying advertisements on a projection screen, or the like.

Similarly, in response to being notified of a social group satisfying the advertisement strategy, the mobile device-based advertisement system 48 selects one or more targeted advertisements for the target users in the social group based on the media content being played by the target users forming the social group. The mobile device-based advertisement system 48 then presents the targeted advertisements by narrowcasting the targeted advertisements to the mobile devices of the target users forming the social group, the mobile devices of all target users in the corresponding sub-area of the geographic area of interest, or the mobile devices of all users in the corresponding sub-area of the geographic area of interest.

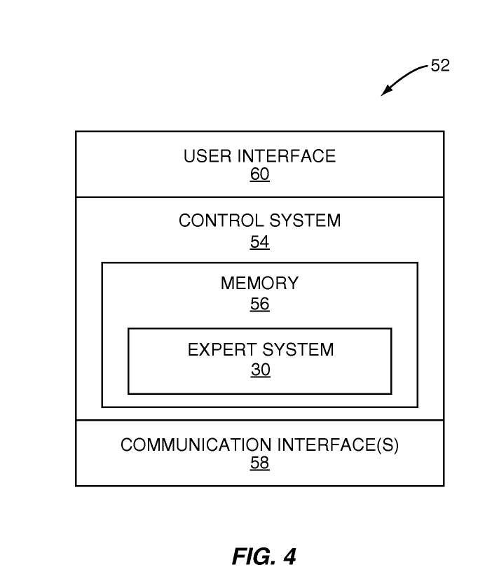

FIG. 4 is a block diagram of a server 52 hosting the expert system 30 of FIG. 3 according to one embodiment of the present invention. Note, however, that the expert system 30 of the present invention is not limited thereto. In general, the server 52 includes a control system 54 having associated memory 56. In this example, the expert system 30 is implemented in software and stored in the memory 56. However, the present invention is not limited thereto. The expert system 30 may be implemented in software, hardware, or a combination thereof. In addition, the server 52 includes one or more communication interfaces 58 communicatively coupling the server 52 to the network 36 (FIG. 3), the advertisement agency 44 (FIG. 3), the environment-based advertisement system 46 (FIG. 3), and the mobile device-based advertisement system 48 (FIG. 3). Lastly, the server 52 may include a user interface 60, which may include components such as, for example, a display, one or more user input devices, or the like.

It should be noted that while the discussion herein focuses on influencing media playback in order to create one or more social groups satisfying an advertisement strategy, the present invention is not limited thereto. The present invention is equally applicable to influencing any type of characteristic of target users in order to prepare them for targeted advertising. For example, the present invention may also be used to influence locations of users to provide any type of service or function. More specifically, the expert system may use text-messages or any other suitable communication means to instruct or influence the users to move to a desired area such as an area near an environmental advertisement presentation device. In this case, the expert system may, for example, influence the target users to move to the desired area using incentives such as coupons, points that may be redeemed for free or discounted products, or the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving input defining a geographic area of interest and a grouping strategy for the geographic area of interest;
identifying a plurality of target users located within the geographic area of interest;
influencing the plurality of target users according to the grouping strategy for the geographic area of interest;
determining when a social group including a subset of the plurality of target users and satisfying the grouping strategy for the geographic area of interest has been created as a result of influencing the plurality of target users; and
providing information related to the creation of the social group to a system providing a service or function to the social group.

2. The method of claim 1 wherein the grouping strategy is an advertisement strategy, and providing the information related to the creation of the social group comprises providing the information related to the creation of the social group to an advertisement system.

3. The method of claim 2 wherein the advertisement system is enabled to select a targeted advertisement for the social group and provide the targeted advertisement to a plurality of users including at least the subset of the plurality of target users forming the social group.

4. The method of claim 2 wherein the information related to the creation of the social group comprises information describing the social group.

5. The method of claim 4 wherein the information describing the social group comprises at least one of a group consisting of: information identifying the advertisement strategy, information identifying the geographic area of interest, and information identifying media content being played by the subset of the plurality of target users forming the social group.

6. The method of claim 4 wherein the information related to the creation of the social group further comprises information identifying a sub-area of the geographic area of interest in which the subset of the plurality of target users forming the social group is located.

7. The method of claim 4 wherein influencing the plurality of target users comprises influencing media playback by the plurality of target users, and the information describing the social group comprises information identifying media content being played by the subset of the plurality of target users forming the social group.

8. The method of claim 4 wherein the information related to the creation of the social group further comprises a number of target users in the subset of the plurality of target users forming the social group.

9. The method of claim 3 wherein the advertisement system is an environment-based advertisement system that presents the targeted advertisement via an environmental advertisement presentation device near or within a sub-area of the geographic area of interest in which the subset of the plurality of target users forming the social group is located.

10. The method of claim 3 wherein the advertisement system is a mobile device-based advertisement system that presents the targeted advertisement by narrowcasting the targeted advertisement to one of a group consisting of: mobile devices of the subset of the plurality of target users, mobile devices of all target users from the plurality of target users located within a sub-area of the geographic area of interest in which the subset of the plurality of target users forming the social group is located, and mobile devices of all users located within the sub-area of the geographic area of interest in which the subset of the plurality of target users forming the social group is located.

11. The method of claim 1 wherein influencing the plurality of target users comprises influencing media playback by the plurality of target users.

12. The method of claim 1 wherein the grouping strategy comprises information defining a desired social group centered around playback of media content and information identifying a minimum number of users in the desired social group.

13. The method of claim 12 wherein the desired social group comprises at least the minimum number of the plurality of target users playing media content as defined by the grouping strategy for the desired social group.

14. The method of claim 12 wherein the grouping strategy defines the desired social group as users playing the same media content.

15. The method of claim 12 wherein the grouping strategy defines the desired social group as users playing media content from the same media genre.

16. The method of claim 1 wherein the target users are users located within the geographic area of interest.

17. The method of claim 2 wherein the advertisement strategy comprises one or more criteria for identifying the plurality of target users, and identifying the plurality of target users comprises identifying users located within the geographic area of interest and satisfying the one or more criteria as the plurality of target users.

18. The method of claim 17 wherein the one or more criteria comprise one or more of the group consisting of: at least one demographic criterion, at least one item required to have been purchased, or at least one media item required to have been played.

19. The method of claim 1 wherein influencing the plurality of target users comprises:
identifying a plurality of initial social groups within the geographic area of interest, each initial social group of the plurality of initial social groups being formed by at least one of the plurality of target users; and
influencing media playback by the plurality of target users in order to refine the initial social groups to create the social group including the subset of the plurality of target users and satisfying the grouping strategy for the geographic area of interest.

20. The method of claim 19 wherein influencing media playback by the plurality of target users comprises influencing media playback by the plurality of target users via one or more media recommendation engines.

21. The method of claim 1 wherein:
influencing the plurality of target users comprises:
identifying a plurality of initial social groups within the geographic area of interest, each initial social group of the plurality of initial social groups being formed by at least one of the plurality of target users; and
influencing media playback by the plurality of target users in order to refine the initial social groups in an attempt to create the social group including the subset of the plurality of target users and satisfying the grouping strategy for the geographic area of interest; and
determining when the social group including the subset of the plurality of target users and satisfying the grouping strategy for the geographic area of interest has been created comprises:
monitoring user interactions in response to influencing the media playback by the plurality of target users;
based on the user interactions, determining whether the social group satisfying the grouping strategy for the geographic area of interest has been created;
wherein if the social group satisfying the grouping strategy has not been created, the steps of influencing media playback by the plurality of target users, monitoring the user interactions in response to the influencing the media playback by the plurality of target users, and determining whether the social group satisfying the grouping strategy for the geographic area of interest has been created based on the user interactions are repeated until the social group including the subset of the plurality of target users and satisfying the grouping strategy for the geographic area of interest has been created.

22. A system comprising:
a) at least one communication interface; and
b) a control system associated with the communication interface and adapted to:
i) receive input, via the at least one communication interface, defining a geographic area of interest and a grouping strategy for the geographic area of interest;
ii) identify a plurality of target users located within the geographic area of interest;
iii) influence the plurality of target users according to the grouping strategy for the geographic area of interest;
iv) determine when a social group including a subset of the plurality of target users and satisfying the grouping strategy for the geographic area of interest has been created as a result of influencing the plurality of target users; and
v) provide information related to the creation of the social group to a second system providing a service or function to the social group.

23. The system of claim 22 wherein the grouping strategy is an advertisement strategy, and the second system is an advertisement system.

24. The system of claim 22 wherein in order to influence the plurality of target users, the control system is adapted to influence media playback by the plurality of target users.

25. The system of claim 22 wherein in order to influence the plurality of target users, the control system is adapted to communicate with one or more media recommendation engines via the at least one communication interface in order to influence media playback by the plurality of target users.
